(19) United States
(12) Patent Application Publication
(10) Pub. No.: US 2022/0203649 A1
(43) Pub. Date: Jun. 30, 2022

(54) ABSORPTIVE NEEDLE-PUNCHED LAYER COMPOSITE

(71) Applicant: ADLER PELZER HOLDING GMBH, Hagen (DE)

(72) Inventors: Volkmar SCHULZE, Schierling (DE); Ray SINGH, Schwelm (DE); Volker KURSCH, Essen (DE)

(73) Assignee: ADLER PELZER HOLDING GMBH, Hagen (DE)

(21) Appl. No.: 17/605,657

(22) PCT Filed: Apr. 21, 2020
(86) PCT No.: PCT/EP2020/061093

§ 371 Date: Oct. 22, 2021

(30) Foreign Application Priority Data
Apr. 23, 2019 (DE) 102019110494.7

(51) Int. Cl. B32B 5/24; B32B 7/09; B32B 5/02; B32B 5/18; B32B 37/00

(52) U.S. Cl. CPC B32B 5/245; B32B 7/09; B32B 5/022; B32B 5/18; B32B 37/0076; B32B 2250/02; B32B 2262/0284; B32B 2266/0278; B32B 2307/72; B32B 2307/732; B32B 2307/102; B32B 2307/718

(57) ABSTRACT

A layer composite is a sandwich structure, in which a PUR foam layer is needle-punched with two nonwovens.

The object of the invention is a layer composite, a sandwich structure, in which a PUR foam layer is needle-punched with at least one nonwoven.

In motor vehicles, thermoformable acoustic and/or stiffening nonwovens are used in particular in the passenger compartment and luggage compartment. These are usually loosely compressed thermoset or thermoplastic bonded textile fibre nonwovens as well as combinations of foam and/or nonwoven layers with the same or different flow resistances. In addition, so-called flow nonwovens are also used to tune the acoustics in a targeted manner.

In order to influence the sound absorption capacity in correlation with the step stiffness, porous, air-open and thus sound-open layers are inserted between the actual upper material and the process-related sealing and heavy layers or the insulation. Polyester and mixed fibre fleeces as well as micro-perforated foils are used as porous, air- and thus sound-open layers. The impact resistance is also influenced by the proportion of bicomponent fibres (BiCo) in the nonwovens.

Single-layer nonwovens, multilayer nonwovens and back-foamed nonwovens are frequently used for headboard material structures. Nonwovens and/or nonwoven combinations are also used in the luggage compartment, primarily for side trim panels, tailgate trim panels and spare wheel wells.

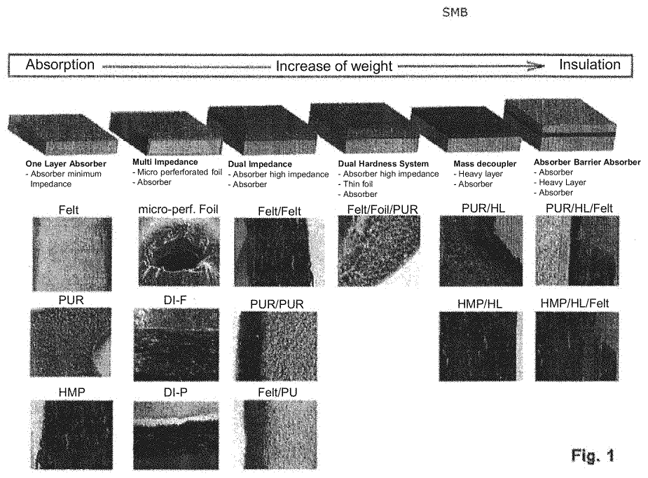

Acoustically effective motor vehicle components, parts, always have a material structure similar to that shown in FIG. 1.

TR 200803410 relates to a process for reusing relatively coarse waste materials, for example textile waste from the manufacture of automotive parts, and products made therefrom. The method is characterized by breaking the waste materials into relatively small pieces. This ground material is then applied to a base. An upper layer of another raw material is then applied to the surface of the waste material, and the layers are bonded together. In TR 200906997, an analogous process is described in which a further hard layer is additionally introduced, using the effect of heat.

DE 10 2015 115 458 A1 [WO 2017/046164 A1] discloses a structural component of a motor vehicle, in particular a wheel arch liner or an engine compartment shield, wherein the structural component comprises, at least in part, a composite material pressed from at least two superimposed nonwoven layers. It is proposed here that a reinforcing layer of at least one laid reinforcing filament is arranged on at least one of the nonwoven layers for reinforcing the composite material.

In US 2018/0251924 A1, a nonwoven composite system is proposed in which, on the one hand, two nonwovens and, on the other hand, two nonwovens with an intermediate film are arranged. Specially modified fibres are used in the nonwovens.

In addition, processes for the production of so-called recycled sandwich nonwovens or components are described in the prior art, in which, on the one hand, pressing technology (DE 10 2016 202 290 A1) and, on the other hand, needling (DE 10 2013 222 403 A1, DE 10 2016 203 348 A1) are used.

WO 2012/052535 A1 relates to a method for producing a composite nonwoven in a continuous process sequence, and to an apparatus for carrying out the method. In this process, a fibre web is formed from a fibre stream by a carding device, and a nonwoven layer of synthetic fibres is subsequently laid on the surface of the fibre web. For this purpose, the fibre web is guided within a suction zone on a delivery belt to a melt blowing device in which the synthetic fibres are laid by melt blowing on the surface of the fibre web. The fibrous web covered with the nonwoven is then laid in a plurality of layers to form the composite nonwoven by a nonwoven laying device.

In DE 10 2016 203 348 A1, a multilayer needle-punched acoustic and/or stiffening nonwoven with two outer cover nonwovens is described with.

a) a first cover nonwoven consisting of a PE adhesive nonwoven with a weight per area of 30 g/m² to 200 g/m², preferably of 50 g/m² to 150 g/m², and a second cover nonwoven consisting of a PP/PET nonwoven with a weight per area of 50 g/m² to 250 g/m², preferably of 80 g/m² to 200 g/m² or

b) wherein both cover nonwovens are each a PP/PET cover nonwoven having a weight per area of 200 g/m² to 800 g/m², preferably 300 g/m² to 600 g/m²,

with a layer of ground material with a weight per area of 250 g/m² to 700 g/m² of PE, PET, PP, two-component fibres and multicomponent fibre material lying each between the cover nonwovens, characterized in that

the ground material contains 5 wt. % to 50 wt. %, preferably 10 wt. % to 40 wt. %, based on the ground material, of dust waste from shredded cotton, PET and two-component fibres.

In the yet unpublished DE 10 2019 104 847, a needle-punched nonwoven for the production of, in particular, textile wheel arch liners is described, which comprises 5 to 14 individual pile layers with a grammage of the nonwoven in the range from 650 g/m² to 1900 g/m², the base nonwoven comprising PP/PET, PP/BiCo/PET, PP/BiCo or PET/BiCo fibres, which is characterized in that

the individual layers—corresponding in particular to the acoustic and mechanical requirements of a textile wheel arch liner—each comprise identical or different materials of ground material and/or fibres and/or flakes and/or powder scattered in layers in identical or different quantities.

In the case of the acoustically effective components and individual components found in the prior art, the layered composites “fleece/foam” are glued together or foamed onto each other.

The task of the present invention compared to the aforementioned prior art thus consists in providing an absorptive layer composite, a sandwich structure, in which a foam layer is needle-punched with a nonwoven layer arranged thereon and optionally thereunder. The focus here is on the one hand the significantly improved acoustic effectiveness with almost the same weight per area and on the other hand the improved acoustic effectiveness as well as the weight advantage.

The aforementioned problem of the present invention is solved in a first embodiment by a nonwoven/PUR foam layer composite comprising at least one PET nonwoven with a grammage of 80 g/m² to 300 g/m², preferably in the range of 100 g/m² to 200 g/m², arranged on the top and/or bottom side of a PUR foam, the PUR foam having a density in the range from 45 g/l to 120 g/l, in particular in the range from 60 g/l to 85 g/l, and a thickness in the range from 4 mm to 20 mm, preferably in the range from 8 mm to 15 mm, which is characterized in that the layer composite is needle-punched.

No acoustically effective components or individual components are known from the prior art in which a foam, a foam layer, is needle-punched with one or more nonwoven layers (cover nonwovens).

In a further alternative embodiment, instead of PUR foam in the density range from 45 g/l to 120 g/l, so-called lightweight foams in the density range from 9 g/l to 40 g/l are used.

The nonwovens (at least one nonwoven) arranged in particular on the top and/or bottom side of the foam can consist of PET or PA fibres, as well as of a fibre mix (mixed fibres); here in particular of PET/PP and PP/PET/cotton fibres.

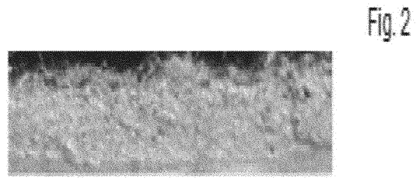

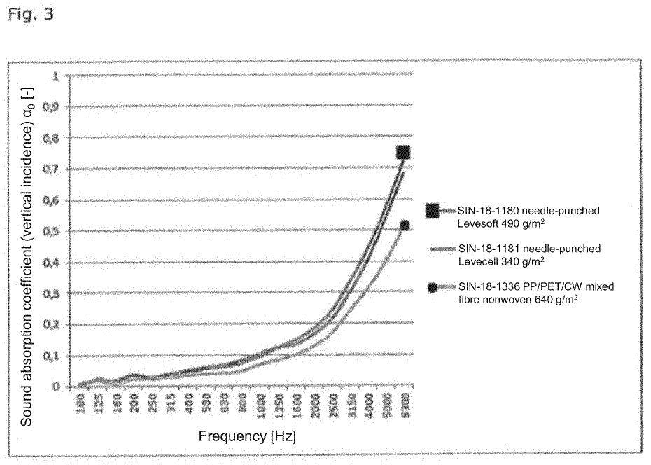

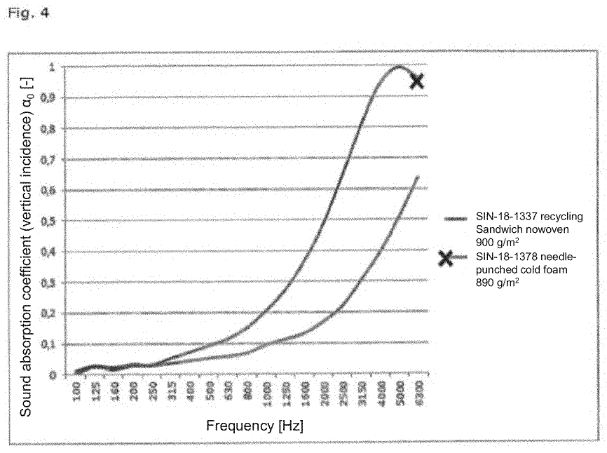

FIG. 2 shows a photo of a needle-punched composite -nonwoven/foam/nonwoven-. In FIGS. 3 and 4, the acoustic performance of the material structures according to the invention is shown in comparison with prior art structures.

FIG. 3 illustrates in particular the weight and acoustic advantages of the inventive solution when using lightweight foams (Leve-Cell® and LeveSoft®) compared to a mixed nonwoven currently in use.

FIG. 4 shows a composite according to the invention with needle-punched cold foam in comparison with a conventional recycled sandwich nonwoven; with almost the same weight per area, the enormous acoustic advantage of the composite according to the invention can be seen.

A further embodiment of the present invention comprises a method for the production of the aforementioned layer composite, which is characterized in that the foam is fed from a roll or as a blank onto the first (lower) cover nonwoven; and subsequently the second (upper) cover nonwoven is passed over it, the entire composite is compressed and needle-punched. If necessary, the second (upper) cover nonwoven is omitted.

Particularly preferably in terms of the present invention, the needling is carried out with fork/fork needles, wreath/wreath needles, fork/wreath needles or felt needles.

Thus, the core of the present invention is the provision of a layer composite comprising a needle-punched nonwoven/foam composite, whereby the acoustic efficiency of this sandwich structure is improved.

The foam cells are punctured during needling. In addition, during needling, individual fibres are pulled out of the sheathing nonwoven into the foam structure. The foam also becomes softer in itself.

The advantage of the present invention is precisely that by needling a foam with nonwovens arranged on both sides or on one side, the acoustic efficiency of the composite is significantly improved and the weight is reduced compared to conventional composites or nonwovens.

The mechanical behaviour of the composite needle-punched with nonwoven is also improved compared to a pure foam.

Example of embodiment:

(a) In a first example, a lightweight PUR foam (Le-veSoft®, 24 g/l, thickness 10 mm) was needle-punched on both sides with a 100 g/m² and 150 g/m² PET fleece.

(b) In a second example, a PUR lightweight foam (Le-veCell®, 12 g/l, thickness 8 mm) was needle-punched on both sides with a 100 g/m² and 150 g/m² commercial PET fleece.

(c) In a third example, a commercial PUR cold foam (65 g/l, thickness 10 mm) was needle-punched on both sides with a 100 g/m² and 150 g/m² commercial PET nonwoven. Needling was carried out on a standard Fehrer machine, the needling density was 20 stitches/cm², the penetration depth 14 mm and the speed 4 m/min. The needles used were commercially available felt needles.

The acoustic performance of the needle-punched foams is shown in FIGS. 3 and 4.

1. Absorptive nonwoven/PUR foam layer composite comprising:
at least one PET nonwoven with a grammage of from 80 g/m² to 300 g/m², arranged on the top and/or bottom side of a PUR foam, the PUR foam having
(a) a density in the range 45 g/l to 120 g/l; or
(b) a density ranging from 9 g/l to 40 g/l; and
each having a thickness in the range of 4 mm to 20 mm,
wherein the layer composite is needle-punched.

2. The absorptive needle-punched layer composite according to claim 1,
wherein the nonwovens arranged on the top and/or bottom side of the foam consist of PET or PA fibres, as well as of a fibre mix (mixed fibres); here in particular of PET/PP and PP/PET/cotton fibres.

3. The absorptive needle-punched layer composite according to claim 1,
wherein the foam is only needle-punched on one side with a nonwoven.

4. The absorptive needle-punched layer composite according to claim 1,
wherein the PET nonwoven has a grammage of 100 g/m² to 200 g/m².

5. The absorptive needle-punched layer composite according to claim 1,
wherein the PUR foam has a density in the range 60 g/l to 85 g/l.

6. The absorptive needle-punched layer composite according to claim 1,
wherein the PUR foam has a density in the range 12 g/l to 32 g/l.

7. The absorptive needle-punched layer composite according to claim 1,
wherein the PUR foam has a thickness in the range 8 mm to 15 mm.

8. The absorptive needle-punched needle-punched layer composite according to claim 1,
wherein the layer composite has two PET nonwovens.

9. Method for the production of an absorptive needle-punched layer composite according to claim 1,
wherein the foam is fed from a roll or as a blank onto the first (lower) cover nonwoven and subsequently the second (upper) cover nonwoven is passed over it, the entire composite is compressed and needle-punched.

10. Method for the production of an absorptive needlepunched layer composite according to claim 1,
wherein the foam is fed from a roll or as a blank onto the (lower) cover nonwoven, the entire composite is compressed and needle-punched.

11. The method according to claim 9, wherein the needling is carried out with fork/fork needles, wreath/wreath needles, fork/wreath needles or felt needles.
